(19) United States
(12) Patent Application Publication
(10) Pub. No.: US 2026/0300648 A1
(43) Pub. Date: Oct. 1, 2026

(54) MULTI-AGENT RULE-BASED SYSTEM MANAGEMENT USING LARGE LANGUAGE MODELS

(71) Applicant: eBay Inc., San Jose, CA (US)

(72) Inventors: Rahul Ajaykumar Agarwal, Santa Clara, CA (US); Shiwam Mittal, Santa Clara, CA (US); Sahithi Mallavarapu, San Jose, CA (US); Hongye Li, Milpitas, CA (US); Dmytro Semenov, San Jose, CA (US)

(73) Assignee: eBay Inc., San Jose, CA (US)

(21) Appl. No.: 19/090,036

(22) Filed: Mar. 25, 2025

(51) Int. Cl. G06F 40/55

(52) U.S. Cl. CPC G06F 40/55

(57) ABSTRACT

Various aspects of the present disclosure relate to rule-based system management using large language models (LLMs). A rule-based system management device receives a first user input indicating to create a rule in a rule-based system. The rule-based system management device searches rules of the rule-based system based on the first user input. The rule-based system management device forms a prompt for a first LLM based on a result of the search and the first user input. The rule-based system management device generates the rule based on inputting the prompt in the first LLM. The rule-based system management device simulates the rule against historic data of the rule-based system to determine a performance metric associated with the rule. The rule-based system management device adds the rule to the rule-based system based on the performance metric.

### BACKGROUND

Web-based platforms (e.g., e-commerce platforms) employ a variety of rule-based systems. Rule-based systems are described as systems that rely on predefined rules to make operational decisions and solve problems. In real-word scenarios, human experts manually generate rules for the rule-based systems. As an example, a human expert creates a rule that blocks a user from creating a profile on a media platform if a username of the user includes some keyword, e.g., a keyword deemed unsafe by the human expert. As time passes, the human experts typically add rules to the rule-based system to address different technical challenges. However, in practice, there is often little to no record of the rules added to the rule-based system and thus, management of the rule-based system is difficult in real word scenarios. For example, if the human expert has limited knowledge about the rules of the rule-based system, the human expert may unintentionally create a rule that is already implemented in the rule-based system which causes inefficient consumption of computational resources. Further, the human expert may unintentionally add a rule to the rule-based that has poor performance because the performance of the rule is not tested or known prior to adding the rule to the rule-based system.

### SUMMARY

Techniques for rule-based system management that leverage language models (LLMs) are described. A rule-based management system receives a first user input indicating to create a rule in a rule-based system and searches rules of the rule-based management system in response to the first user input. Based on a result of the search and the first user input, the rule-based management system forms a prompt for a machine learning model (e.g., an LLM) and generates the rule based on inputting the prompt in the machine learning model. Upon generating the rule, the rule-based management system simulates the rule against historic data of the rule-based system to determine a performance metric associated with the rule and adds the rule to the rule-based system based on a result of the determination.

The Summary introduces a selection of concepts in a simplified form. Further aspects are described in the Detailed Description. The Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the below accompanying FIGS. Entities represented in the FIGS. are indicative of one or more entities and thus reference is made interchangeably to single or plural forms of the entities in the discussion.

FIG. 1 illustrates an example of a system that supports multi-agent rule-based system management using one or more LLMs as described herein.

FIG. 2 illustrates an example of a flow that supports multi-agent rule-based system management using one or more LLMs as described herein.

FIG. 3 illustrates an example of a component diagram that supports multi-agent rule-based system management using one or more LLMs as described herein.

FIG. 4 illustrates an example of a component diagram that supports multi-agent rule-based system management using one or more LLMs as described herein.

FIG. 5 illustrates an example of a training procedure that supports multi-agent rule-based system management using one or more LLMs as described herein.

FIG. 6 illustrates an example of a flow that supports multi-agent rule-based system management using one or more LLMs as described herein.

FIG. 7 illustrates an example of a flow that supports multi-agent rule-based system management using one or more LLMs as described herein.

FIG. 8 illustrates an example of a procedure that supports multi-agent rule-based system management using one or more LLMs as described herein.

FIG. 9 illustrates an example of a system that supports multi-agent rule-based system management using one or more LLMs as described herein.

### DETAILED DESCRIPTION

### Overview

Rule-based systems enable web-based platforms to solve or detect problems using a set of pre-defined rules. As fraud is detected, for instance, human experts manually add rules to the rule-based system. Although new rules are added to the rule-based system, in real-world scenarios there is often little to no documentation summarizing or categorizing the rules of the rule-based system. As a result, human experts have limited knowledge of the rules currently employed by the rule-based system. Thus, the human experts may unintentionally create duplicate rules in the rule-based system. Further, using these techniques, each rule of the rule-based system is manually entered by the human expert which consumes valuable time and processing resources. As another result of the above-described techniques, the rule-based system does not test the efficacy of a rule prior to adding the rule to the rule-based system which potentially results in a rule with poor performance being added to the rule-based system.

Accordingly, an enhanced rule-based management system is described herein. The rule-based management system receives, via a user interface, a request to create a rule in a rule-based system. As an example, the rule-based management system receives a request to create a rule that blocks the creation of accounts for users based in CountryX. In response to the request, the rule-based management system may search the rules of the rule-based system for the requested rule or a similar rule. Based on a result of the search, the rule-based management system forms a prompt for a first LLM. In some implementation, the rule-based management system forms the prompt if the rule-based management system is unable to find the requested rule. The prompt includes details of the rule, e.g., conditions checked by the rule and/or a desired action of the rule. For example, the prompt states “Generate an account registration rule that checks if the user registration country is CountryX and sets action to block if the user registration country is CountryX.”

Upon generating the prompt, the rule-based management system inputs the prompt in the first LLM and the first LLM creates the rule using the prompt. The rule output by the LLM may be a portion of code that can be used by the rule-based system to interpret the rule. The rule-based management system is further configurable to test an efficacy of the rule. For example, the rule-based management system simulates the rule against historic data and determines a performance metric (e.g., a service level agreement (SLA) metric) of the rule. In some examples, the rule-based management system automatically publishes the rule to the rule-based system if the performance metric satisfies a threshold. In another example, the rule-based management system displays the rule and the corresponding performance metric to a user and the user makes a determination to add the rule to the rule-based system.

Additionally of alternatively, the rule-based management system utilizes one or more second LLMs to obtain insight information. For example, the rule-based management system receives, via the user interface, user input requesting insight information for a policy of a web-based platform implementing the rule-based system. Based on the user input, the rule-based management system generates one or more queries using a second LLM and obtains embeddings data from one or more databases using the one or more queries. The rule-based management analyzes the embeddings data and generates the insight information for the policy based on the analysis. In some examples, the rule-based management system displays the insight information via the user interface. The insight information includes one or more of a list of rules related to the policy, a usage history of the rules related to the policy, performance metrics for the rules related to the policy, a pair of co-firing rules, etc.

The techniques as described herein support increased efficiency in rule-based management as compared to conventional techniques. For example, by searching the rules of the rule-based system, the rule-based management system decreases a likelihood that duplicate rules are employed by the rule-based system. Further, by utilizing an LLM to generate new rules, the rule-based management system decreases latency related to human experts manually entering new rules. Additionally, by testing a performance of the rule, the rule-based management system ensures that a minimal level of performance is met by the rule-based system.

### Example System for Rule-based System Management

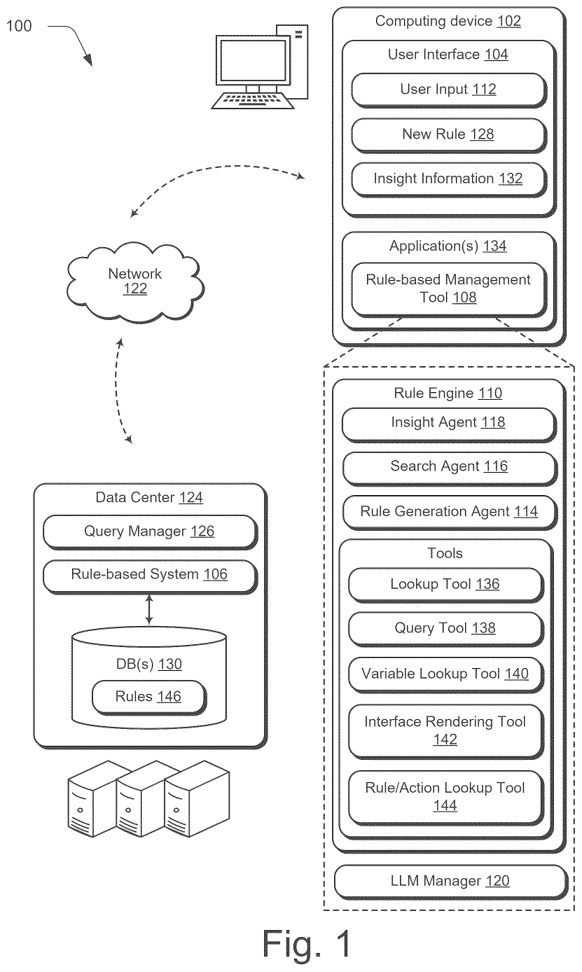

FIG. 1 illustrates an example of a system 100 that supports multi-agent rule-based system management using one or more LLMs as described herein. In some examples, the system 100 includes a computing device 102 and a data center 124. As shown in FIG. 1, the computing device 102 and the data center 124 are communicatively coupled to one another via a network 122. The network 122 is configurable in a variety of ways, an example of which is the Internet.

The computing device 102 is also configured in a variety of ways. For example, the computing device 102 is configured as a desktop computer, a laptop computer, a mobile device, an IoT device, a wearable device (e.g., a smart watch, a ring, or smart glasses), an AR/VR device (e.g., the smart glasses), a server, etc. As such, the computing device 102 ranges from a full resource device with substantial memory and memory resources to a low-resource device with limited memory and processing resources. Although the computing device 102 is illustrated as a singular device, it is understood that the computing device 102 is also representative of multiple of different devices, e.g., multiple servers of a server farm. One or more users interact with the computing device 102. The one or more users are a person, a machine, or other means of interacting with the computing device 102.

In one or more implementations, the computing device 102 includes one or more applications 134. For example, the computing device 102 includes a rule-based management tool 108. Applications 134 support communication of data across the network 122, such as between the computing device 102 and the data center 124. An application 134 is a web-based computer applications, such as a mobile application or a desktop application, that facilitates user interaction with one or more features of the data center 124.

As shown in FIG. 1, the computing device 102 displays a user interface 104. Using the user interface 104, the application 134 receives inputs and deliver outputs. For instance, through interaction of the one or more users with the user interface 104, the application 134 receives user input via the computing device 102. Examples of inputs include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. Based on the received user input, the application 134 causes various systems of the computing device 102 to output information via the user interface 104. For instance, the computing device 102 displays the user interface 104 via display devices or by making accessible voice-based user interfaces.

In some examples, the user interface 104 includes or is an example of a graphical user interface (GUI) associated with the application. The one or more users input information via interactable elements of the GUI, e.g., fill in a text element, elect a selectable element, or the like. For instance, the user inputs a search term (e.g., one or more keywords) into a search function of the application and the application returns a list of search results based on the search term.

The data center 124 is an example of one or more servers configured to provide services, data, or resources to one or more devices (e.g., the computing device 102 or another client device) over the network 122. As shown in FIG. 1, the data center 124 operates according to a rule-based system 106. That is, the data center 124 performs one or more actions in accordance with a set of pre-defined rules 146. In one implementation, a user of a client device in communication with the data center 124 requests (e.g., via a user interface of the client device) to register an account with a web-based platform managed by the data center 124, e.g., an online marketplace. In response to the request, the data center 124 registers the account based on the pre-defined rules 146 of the rule-based system 106. For example, a predefined rule 146 of the rule-based system 106 indicates to block registration of an account that includes some keyword. Thus, if the account includes the aforementioned keyword, the data center 124 blocks the registration request and does not allow the user to register the account with the web-based platform.

The data center 124 also includes databases 130. The databases 130 are configurable to store information, e.g., information associated with the rule-based system 106, information associated with a web-based platform managed by the data center 124, etc. For example, the databases 130 stores the rules 146 of the rule-based system 106, rule-firing data (e.g., a firing rate of the rules, counters indicating a firing count for each of the rules, or one or more pairs of co-firing rules), embeddings data associated with the rule-based system 106, etc. Embeddings are described as vectors that represent words, images, video, etc. in a form that is easily understandable to machine learning models.

Additionally, the data center 124 includes a query manager 126. The query manager 126 is configured to route a query (e.g., a query received from the computing device 102) to an applicable database 130 and retrieve information requested by the query. In one example, the query manager 126 receives a query requesting a list of top firing rules for a policy of the web-based platform managed by the data center 124. In response to the query, the query manager 126 routes the query to the applicable database 130 (e.g., the database configured to store the rule-firing data associated with the rule-based system 106) and retrieves the information by querying the applicable database 130 using the query.

In some examples, the rule-based management tool 108 is configured to manage aspects of the rule-based system 106 of the data center 124 using a rule engine 110. The rule engine 110 includes at least a rule generation agent 114, a search agent 116, and an insight agent 118. Upon receiving the user input 112 from one or more users via the user interface 104, the rule engine 110 of the rule-based management tool 108 routes the user input 112 to one or more of the rule generation agent 114, the search agent 116, or the insight agent 118, e.g., based on one or more keywords of the user input.

In one implementation, the user input 112 includes a request for insight information. For example, the user input 112 includes a query that states “Show me insight into Site Limits policy at Listing flow.” Based on the query, the rule engine 110 identifies the insight agent 118 and routes the query to the insight agent 118. The insight agent 118 performs one or more actions in response to receiving the query. In some implementations, the insight agent 118 employs a lookup tool 136. Using the lookup tool 136, the insight agent 118 communicates with the data center 124 and searches databases 130 (e.g., a database storing embeddings data associated with the rule-based system 106) using keywords included in the query (e.g., policy or policy flow) and obtains some information.

Additionally, the insight agent 118 employs a query tool 138. Using the query tool 138, the insight agent 118 forms one or more queries and send the one or more queries to the query manager 126 of the data center 124. As an example, the query tool 138 forms a query that states “Are there any co-firing rules associated with the Site Limits policy at Listing flow?” The query manager 126 analyzes the query generated by the query tool 138 and queries the applicable database 130 (e.g., a database storing rule firing data) to obtain some information, e.g., one or more pairs of co-firing rules.

Additionally, the insight agent 118 employs a user interface rendering tool 142. Using the user interface rendering tool 142, the insight agent 118 analyzes the information obtained from the lookup tool and/or the query tool and summarize the information in a structured manner for display to the user via the user interface 104. The summarized information displayed to the user may be known as insight information 132.

As an example, the user interface rendering tool 142 generates a table indicating actions associated with a policy flow, a number of rules for each action, top-firing rules associated with each action, and a firing count for each action. An example of a table generated by the user interface rendering tool in response to the user input “Show me insight into Site Limits policy at Listing flow” is illustrated in Table 1 below. The user interface rendering tool 142 is also configurable to generate a graph that illustrates the firing count for each action over time. The user interface rendering tool 142 is further configurable to display one or more pairs of co-firing rules, e.g., the user interface displays text that reads “Rule 1210878 and Rule 1254544 fire at the same time 99.44% of the time”.

TABLE 1

| | | Number | | |
|---|---|---|---|---|
| Flow | Actions | of Rules | Rule IDs of Top Firing Rules | Total Counts |
| LISTING | BLOCK | 46 | 1246253, 1246252, . . . , | 63,885,662 |
| | | | 1245485 | |
| LISTING | FLAG_DELAY | 7 | 1247465, 1245649, . . . , | 18,959,025 |
| | | | 1125546 | |
| LISTING | FLAG_ITEM | 2 | 652292, 654722 | 16,300 |

In one or more other examples, the user input 112 includes a search for one or more variables of the rule-based system 106. For example, the user input includes a query that states “Are there any gibberish variables?” Each rule of the rule-based system 106 is associated with one or more variables that define the scope of the rule. Based on the query, the rule engine 110 identifies the search agent 116 and route the user input to the search agent 116. The search agent 116 performs one or more actions in response to receiving the query. In some implementations, the search agent 116 employs a variable lookup tool 140. Using the variable lookup tool 140, the search agent 116 communicates with the data center 124 and searches databases 130 (e.g., a database storing embeddings data associated with the rule-based system) using keywords included in the query (e.g., variable) and obtains some information, e.g., all applicable variables in the rule-based system 106.

Additionally, the search agent 116 employs a rule and action lookup tool 144. Using the rule and action lookup tool 144, the search agent 116 communicates with the data center 124 and search databases 130 (e.g., a database storing rules/actions associated with the rule-based system 106) using keywords included in the query (e.g., variables) and obtains some information, e.g., rules/actions associated with the variables.

Additionally, the search agent 116 employs the user interface rendering tool 142. Using the user interface rendering tool 142, the search agent 116 analyzes the obtained information (e.g., information obtained from the variable lookup tool and the rule and action lookup tool) and summarizes the information in a structured manner for display to the user via the user interface 104. As an example, the user interface rendering tool 142 generates a list of rules as well as one or more attributes of each rule, e.g., return type and past performance metrics, e.g., service level agreement (SLA). An example of a table generated by the user interface rendering tool 142 in response to the user input “Are there any gibberish variables?” is illustrated in Table 2 below.

TABLE 2

| | | Rule Variable | Return | Avg. | p99 SLA |
|---|---|---|---|---|---|
| RBO | Variable | Template | Type | SLA (ms) | (ms) |
| AccountSettingsRbo | Is New First Name | AccountSettings: | Boolean | .0089 | 0 |
| | Gibberish | Is New First | | | |
| | | Name Gibberish? | | | |
| AccountSettingRbo | Is New Last Name | AccountSettings: | Boolean | 1.0046 | 38 |
| | Gibberish | Is New Last | | | |
| | | Name Gibberish? | | | |
| RegistrationRbo | isGibberish<Value> | Registration: | Boolean | None | None |
| | | isGibberish<Value> | | | |
| FunctionsRbo | isGibberish | Functions: | Boolean | 6.0128 | 52 |
| | | isGibberish | | | |

In another implementation, user input 112 includes a request for a new rule to be added to the rule-based system 106. Based on this user input 112, the rule engine 110 identifies the rule generation agent 114 and routes the user input 112 to the rule generation agent 114. In some examples, the rule generation agent 114 performs similar actions as the search agent 116 to search for a pre-existing rule corresponding to the request. If the pre-existing rule is not found via the search or the user deems that a pre-existing rule 146 does not meet a desired level of performance, the rule generation agent 114 creates a new rule 128 corresponding to the request. Additionally, the rule generation agent 114 employs the user interface rendering tool 142. Using the user interface rendering tool 142, the rule generation agent 114 displays the new rule 128 to the user via the user interface 104. The rule generation agent 114 also tests a performance of the new rule. That is, the rule generation agent 114 simulates the rule against historical data of the rule-based system 106. If the performance of the new rule 128 meets or exceeds a predetermined threshold, the rule generation agent 114 forwards the new rule 128 to the rule-based system 106 and the rule-based system 106 activates the rule for use in the rule-based system 106. In some examples, the user decides whether to update the rule-based system 106 such that the rules 146 include the new rule 128.

As shown in FIG. 1, the rule-based management tool 108 further includes an LLM manager 120 configured to manage (or train) one or more LLMs. LLMs are built on machine learning (e.g., a type of neural network called a transformer model) and are trained to understand and generate natural language in response to a prompt or other input. LLMs are pre-trained on a diverse test data set to learn structure, grammar, and semantics of language. Further, LLMs use deep learning to understand how characters, words, and sentences function together.

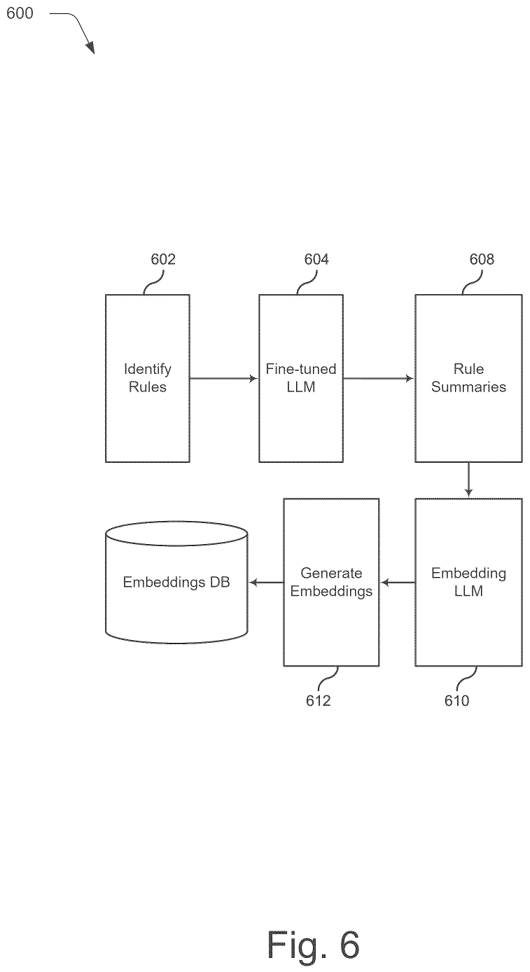

In some implementations, the LLM manager 120 is configured to train a rule generation LLM to output a rule based on a prompt generated from user input which is described in more detail with reference to FIG. 6. Additionally, or alternatively, the LLM manager 120 is configured to train both the rule generation LLM and a query generation LLM to generate one or more queries based on user input. The rule engine 110 utilizes the one or more LLM models managed (or trained) by the LLM manager 120 to perform the one or more actions as described above. For example, the insight agent 118 of the rule engine 110 utilizes the query generation LLM trained by the LLM manager 120 to form the one or more queries in response to user input 112, e.g., a request for insight information. Additionally, or alternatively, the rule generation agent 114 of the rule engine 110 utilizes the rule generation LLM to generate the new rule 128 in response to user input 112 (or a request for a new rule) and/or prompts generated from the user input 112.

### Example Flow Diagram for Rule-based System Management

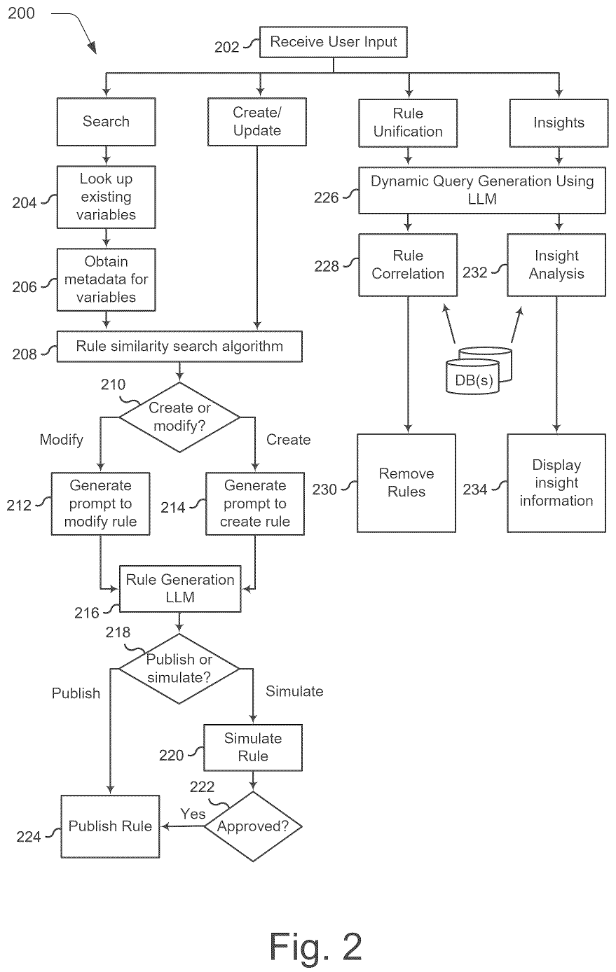

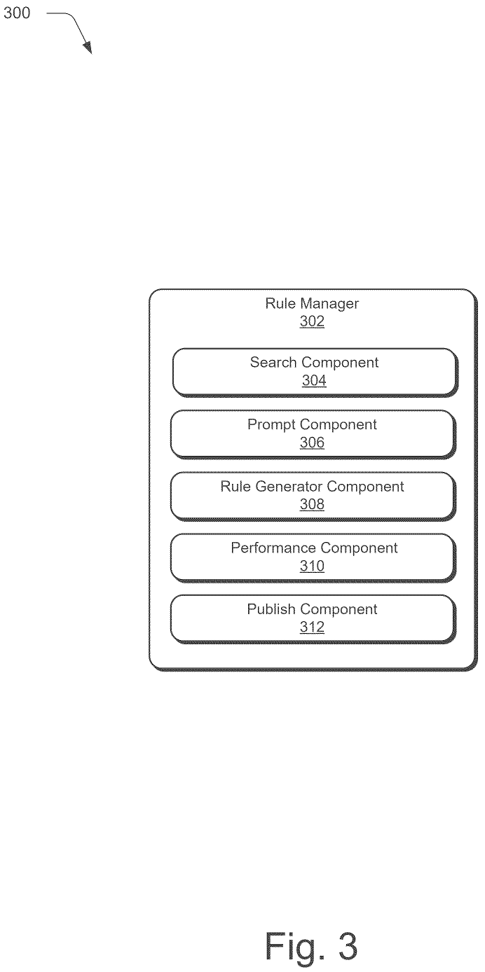

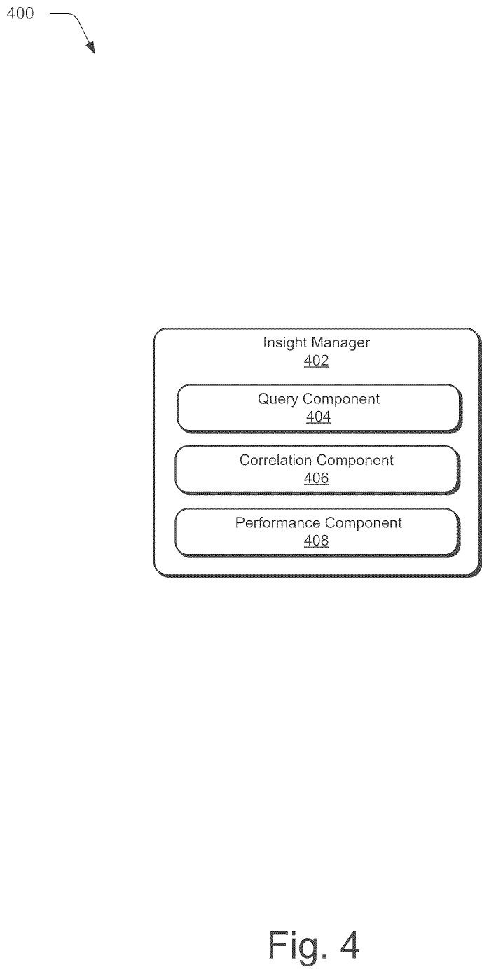

FIG. 2 illustrates a flow 200 that supports multi-agent rule-based system management using one or more LLMs as described herein. The flow 200 is performed by aspects of FIGS. 1, 3 and 4. For example, (block 204) through (block 224) of the flow 200 are performed by a rule manager 302 (e.g., a search component 304, a prompt component 306, a rule generator component 308, a performance component 310, or a publish component 312) as described with reference to FIG. 3 and (block 226) through (block 234) are performed by an insight manager 402 (e.g., a query component 404, a correlation component 406, or a performance component 408) as described with reference to FIG. 4.

At (block 202), the rule-based management tool 108 receives a user input via a user interface. The rule-based management tool 108 is configured to manage one or more aspects of a rule-based system implemented for a web-based system.

In one implementation, the user input includes a search query. If the user input includes the search query, the rule-based management tool 108 routes the user input to a search function of the rule-based management tool 108.

In some examples, the search query includes a variable level search. For example, the search query states “Is there any variable for detecting URLs in business name at PPA?” or “Are there any variables for authentication method at sign in?” In such case, at (block 204) and as part of the search function, the rule-based management tool 108 (or the search component 304) performs a lookup of existing variables of the rule-based system. That is, the rule-based management tool 108 compares embedding data of the variable(s) of the search query to embedding data stored in one or more databases associated with the rule-based system to determine any existing variables that match the variable provided in the search query. Further, at (block 206), the rule-based management tool 108 (or the search component 304) obtains metadata for the existing variables (e.g., SLA metrics, availability, checkpoints, enabled/disabled status, etc.) and provide the existing variables and the metadata to the user via display on the user interface. An example of a table generated in response to the user input “Is there any variable for detecting URLs in business name at PPA?” is illustrated in Table 3.

TABLE 3

| | | Rule Variable | Return | Avg. SLA | p99 SLA |
|---|---|---|---|---|---|
| RBO | Variable | Template | Type | (ms) | (ms) |
| RegistrationRbo | Business Name | Registration: | Boolean | 0.0219 | 1 |
| | has any | Business Name has | | | |
| | <safelinkEnum> | any <safelinkEnum> | | | |
| | URL Present | URL Present | | | |
| RegistrationRbo | Get count of all | Registration: Get | int | 0.0071 | 0 |
| | URLs in Business | count of all URLs in | | | |
| | Name | Business Name | | | |

In other implementations, the search query includes a rule level search. In such case, the rule-based management tool 108 (or the search component 304) proceeds to (block 208) and input the user input as well as any variables and/or the metadata determined at (block 204) and (block 206) in a rule similarity search algorithm to find the requested rule. Details of the rule similarity search algorithm are described with reference to FIG. 6. Upon locating the requested rule, the rule-based management tool 108 displays the rule to the user via the user interface. If the rule-based management tool 108 is unable to locate the requested rule, the rule-based management tool 108 creates the requested rule using a create/update function of the rule-based management tool 108 as described below.

In another implementation, the user input includes a request to create a rule for the rule-based system. For example, the request states “Can you add the variable get count of all URLs in business name to rule 1250855?” If the user input includes the request to create the rule, the rule-based management tool 108 routes the user input to the create/update function of the rule-based management tool 108.

In such case, at (block 208) and as part of the create/update function, the rule-based management function (or the search component 304) performs a search by inputting the request into the rule similarity search algorithm. Using the rule similarity search algorithm, the rule-based management tool 108 determines whether existing rules in the rule-based system match the requested rule. If the existing rules do not match the requested rule, the rule-based management tool 108 continues to (block 210).

At (block 210), the rule-based management tool 108 determines whether to update an existing rule of the rule-based system or generate a new rule according to the request. The rule-based management tool 108 makes such determination based on user preference. If the determination includes updating an existing rule, the rule-based management tool 108 (or the prompt component 306) proceeds to (block 212) and generate a prompt to modify the existing rule. If the determination includes generating a new rule, the rule-based management tool 108 (or the prompt component 306) proceeds to (block 214) and generate a prompt to create a new rule.

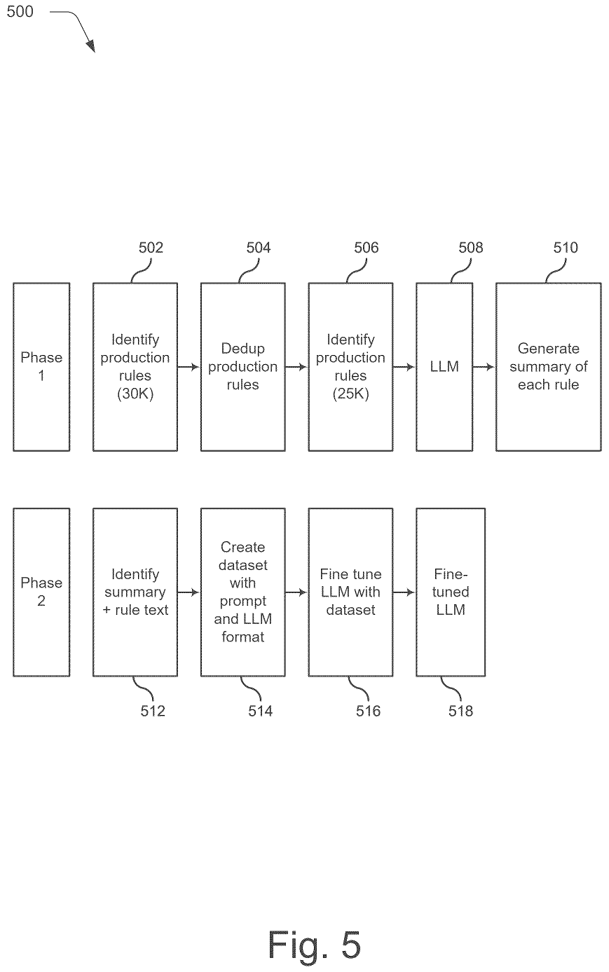

The prompt includes a short description of the requested rule, e.g., a type of rule, one or more conditions checked by the rule, or an action of the rule. For example, the rule-based management tool 108 (or the prompt component 306) generates a prompt that states “Generate an elvis rule with the following requirements: The elvis rule checks the following conditions: user registration country is US, seller segment is B_CASUAL, and RTAM Selling Metrics open GMV amount is >=1000, and then sets action to block payout.” At (block 216), the rule-based management tool 108 (or the rule generator component 308) generates a new rule based on the prompt. For example, the rule-based management tool 108 feeds the prompt into a rule generation LLM and the rule generation LLM outputs a rule based on the prompt. Details of the rule generation LLM are described with reference to FIG. 5. An example of a rule generated by the rule generation LLM in response to the prompt “Generate an elvis rule with the following requirements: The elvis rule checks the following conditions: user registration country is US, seller segment is B_CASUAL, and RTAM Selling Metrics open GMV amount is >=1000, and then sets action to block payout” is illustrated below:

```
elvis RULE
BLOCK_PAYOUT_US_B_CASUAL_RTAM_OPEN_GMV_1000_1230379
  IF
    User: Registration Country Enum==UNITED_STATES
    AND Seller:Seller Segment == B_CASUAL
    AND RTAM_SellingMetric:Seller:Open GMV Amount >= 1000
  THEN
    Result: set action to (PAYOUT_BLOCK) for (PAYOUT_RISK_BLOCK);
  EXIT ;
  END
```

At (block 218), the rule-based management tool 108 determines whether to publish the generated rule or simulate the generate rule. This determination is based on user preference. If the determination includes publishing the rule, the rule-based management tool 108 (or the publish component 312) continues to (block 224) and publish the rule to the rule-based system. That is, the rule-based management tool 108 activates the rule in the rule-based system.

If the determination includes simulating the rule, the rule-based management tool 108 (or the performance component 310) proceeds to (block 220) and simulate the rule against historic data to determine a performance metric of the rule. In some examples, the rule-based management tool 108 generates a rule efficacy report and/or a rule business metrics report based on simulating the rule. The rule-based management tool 108 proceeds to (block 222) and determines whether the rule is approved for publication. The rule-based management tool 108 determines the rule is approved for publication if the performance metric of the rule meets or exceeds a predetermined threshold. If the rule is approved for publication, the rule-based management tool 108 (or the publish component 312) proceeds to (block 224) and publishes the rule to the rule-based system.

In another implementation, the user input includes a request for insight information. For example, the request states “Show me insight information into Mass Reg Production at PPA?” If the user input includes a request for insight information, the rule-based management tool 108 routes the user input to one or both of an insight function or a rule unification function of the rule-based management tool 108.

In such case, at (block 226), the rule-based management tool 108 (or query component 404) inputs the request for insight information into one or more query generation LLMs. The one or more query generation LLMs understand the request for insight information and generate one or more queries for one or both of the rule unification function or the insight function based on the request. For example, the one or more query generation LLMs generates a query for the rule unification function which states, “Find co-firing rules associated with Mass Reg Production at PPA.” As another example, the one or more query generation LLMs generates a query for the insight function which states, “Find the actions associated with Mass Reg Production at PPA?”

At (block 228) and as part of the rule unification function, the rule-based management tool 108 (or the correlation component 406) performs rule correlation. That is, the rule-based management tool 108 queries databases (e.g., databases storing rule firing data of the rule-based system) using the one or more queries generated for the rule unification function and obtain information from the databases. Using the information, the rule-based management tool 108 (or the correlation component 406) determines one or more pairs of co-firing rules, e.g., rules that fire at a same time. At (block 230), the rule-based management tool 108 (or the correlation component 406) removes one of the co-firing rules from the rule-based system. The rule-based management tool 108 removes the rule whose corresponding performance metric is lowest of the pair.

At (block 232) and as part of the insight function, the rule-based management tool 108 (or the performance component 410) performs an insight analysis. That is, the rule-based management tool 108 queries databases (e.g., databases storing action data, rule data, embedding data, etc. for the rule-based system) using the one or more queries generated for the insight function and obtain information from the databases. Using the information, the rule-based management tool 108 (or the performance component 410) determines insight information (e.g., actions, number of rules associated with each action, etc.) At (block 234), the rule-based management tool 108 (or the performance component 410) provides the insight information to the user via the user interface.

### Example Devices for Rule-based System Management

FIG. 3 illustrates an example of a component diagram 300 of a rule manager 302 that supports multi-agent rule-based system management using one or more LLMs as described herein. The rule manager 302 is an example of a rule generation agent 114 or a search agent 116 as described with reference to FIG. 1. The rule manager 302, or various components thereof, is an example of means for performing various aspects of multi-agent rule-based system management using one or more LLMs described herein. For example, the rule manager 302 includes a search component 304, a prompt component 306, a rule generator component 308, a performance component 310, and a publish component 312. Each of these components communicate, directly or indirectly, with one another.

The search component 304, the prompt component 306, the rule generator component 308, the performance component 310, and the publish component 312 are implemented in code (e.g., as software or firmware) executed by a processor. If implemented in code executed by a processor, the functions of the search component 304, the prompt component 306, the rule generator component 308, the performance component 310, and the publish component 312 are performed by a general-purpose processor, a digital signal processor (DSP), a central processing unit (CPU), an ASIC, an FPGA, a microcontroller, or any combination thereof.

The search component 304 is capable of, configured to, or operable to support a means for searching rules of the rule-based system based on first user input indicating to create a rule in a rule-based system. The prompt component 306 is capable of, configured to, or operable to support a means for forming a prompt for a first LLM based on a result of the search and the first user input. The rule generator component 308 is capable of, configured to, or operable to support a means for generating the rule based on inputting the prompt in the first LLM. The performance component 310 is capable of, configured to, or operable to support a means for simulating the rule against historic data of the rule-based system to determine a performance metric associated with the rule. The publish component 312 is capable of, configured to, or operable to support a means for adding the rule to the rule-based system based on the performance metric.

The search component 304 is further capable of, configured to, or operable to support a means for determining that none of the rules of the rule-based system match the rule based on the search. To support generating the rule, the rule generator component 308 is capable of, configured to, or operable to support a means for generating a new rule or modifying an existing rule of the rule-based system. The performance component is further capable of, configured to, or operable to support a means for displaying, via a user interface, the rule.

FIG. 4 illustrates an example of a component diagram 400 of an insight manager 402 that supports multi-agent rule-based system management using one or more LLMs as described herein. The insight manager 402 is an example of the insight agent 118 as described with reference to FIG. 1. The insight manager 402, or various components thereof, is an example of means for performing various aspects of multi-agent rule-based system management using one or more LLMs described herein. For example, the insight manager 402 includes a query component 404, a correlation component 406, and a performance component 408. Each of these components communicate, directly or indirectly, with one another.

The query component 404, the correlation component 406, and the performance component 408 are implemented in code (e.g., as software or firmware) executed by a processor. If implemented in code executed by a processor, the functions of the query component 404, the correlation component 406, and the performance component 408 are performed by a general-purpose processor, a DSP, a CPU, an ASIC, an FPGA, a microcontroller, or any combination thereof.

The query component 404 is capable of, configured to, or operable to support a means for generating a query based on inputting a second user input requesting insight information for a policy of a rule-based system in a second LLM. The correlation component 406 or the performance component 408 is capable of, configured to, or operable to support a means for obtaining, from one or more databases, embedding data related to rules or policies of the rule-based system based on the query. The performance component 408 is capable of, configured to, or operable to support a means for generating insight information based on the embedding data.

The correlation component 406 is further capable of, configured to, or operable to support a means for determining a pair of co-firing rules based on the embedding data and removing one of the rules of the pair of co-firing rules from the rule-based system.

### Example Model Training Procedure for Rule-based System Management

FIG. 5 illustrates an example of a training procedure 500 that supports multi-agent rule-based system management using one or more LLMs as described herein. The training procedure is implemented by aspects of FIGS. 1 and 3. For example, the training procedure is implemented by the LLM manager 120 of FIG. 1 or the rule manager 302 of FIG. 3.

Phase 1 of the training procedure includes (block 502) through (block 510). At (block 502), the training procedure includes identifying a first set of rules associated with a rule-based system. In one example, the first set of rules includes 30,000 production rules, or listing violation inspection services (eLVIS) production rules.

At (block 504), the training procedure includes performing deduplication (or dedup) on the first set of rules identified at (block 502). Deduplication is described as the process of removing duplicate data from a set of information. Thus, deduplication in this case includes removing duplicate rules from the first set of rules.

At (block 506), the training procedure includes identifying a second set of rules. The second set of rules are the first set of rules with duplicate rules removed. Thus, the second set of rules includes a number of rules that is less than a number of rules included in the first set of rules. For example, the second set of rules includes 25,000 production rules. Additionally, the second set of rules includes unique (or different) rules.

At (block 508), the training procedure includes inputting the second set of rules along with a prompt into an LLM. The prompt instructs the LLM to generate a text summary (e.g., a 400-character summary) of each rule of the second set of rules. For example, the prompt states “Please provide a 400-character length summary for elvis rule Flag_at_FI_Bank_Add_with_Known_Behavior_Score_LT03_No_Active_Bank_1232629.”

At (block 510), the training procedure includes generating a text summary for each rule of the second set of rules using the LLM. An example text summary includes “The elvis rule ‘Flag_at_FI_Bank_Add_with_Known_Behavior_Score_LT03 No_Active_Bank_1232629′ checks if a seller is adding a new bank account, is a P2 seller, and a has a known behavior model score less than 0.3. If all conditions are true, the rule sets the action to ‘FLAG_USER’ for all.”

Phase 2 of the training procedure includes (block 512) through (block 518). At (block 512), the training procedure includes identifying a text summary output from the LLM and a corresponding rule of the second set of rules.

At (block 514), the training procedure includes creating a data set where each rule of the second set of rules has a corresponding text summary and rule text pair.

At (block 516), the training procedure includes feeding the data set into the LLM to fine-tune (or train) the LLM.

At (block 518), the training procedure includes generating a fine-tuned version of the LLM. The fine-tuned version of the LLM generate rules based on user input (e.g., a request to create a new rule for the rule-based system) and/or a prompt generated from user input. The fine-tuned LLM version of the LLM includes the rule generation LLM as described with reference to FIG. 1.

### Example Search Algorithm for Rule-based System Management

FIG. 6 illustrates an example of a flow 600 that supports multi-agent rule-based system management using one or more LLMs as described herein. The flow 600 provides a framework for the rule similarity search algorithm as described with reference to FIG. 1 and FIG. 2.

At (block 602), the rule-based management tool 108 identifies a set of rules, e.g., a set of production rules of a rule-based system.

At (block 604), the rule-based management tool 108 passes the set of rules to a first LLM. The first LLM is an example of the fine-tuned LLM as described with reference to FIG. 5.

At (block 608), the LLM outputs a text summary for each rule. The text summary is less than or equal to 400 characters.

At (block 610), the rule-based management tool 108 passes the text summaries to a second LLM. In some examples, the second LLM is configured to generate embeddings.

At (block 612), the second LLM generates embeddings for each of the text summaries and then stores the embeddings in a database.

As described with reference to FIG. 1, the rule-based management tool 108 utilizes a rule similarity search algorithm during a search function of the rule-based management. As part of the search algorithm, the rule-based management tool 108 converts user input (e.g., a search query) into embeddings and compare the embeddings to the embeddings stored in the database. Based on the comparison, the rule-based management tool 108 finds one or more rules that are closest to the rule referred to in the search query.

### Example Insight Analysis for Rule-based System Management

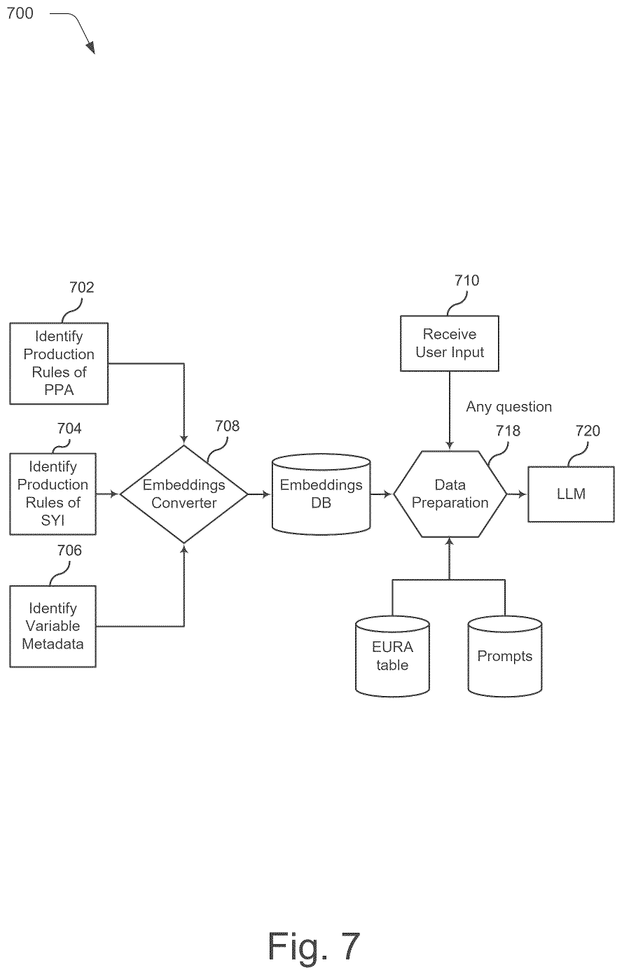

FIG. 7 illustrates an example of a flow 700 that supports multi-agent rule-based system management using one or more LLMs as described herein. The flow 700 provides a framework for the rule unification function and the insight function as described with reference to FIG. 1.

At (block 702), (block 704), and (block 706), a rule-based management tool 108 identifies information associated with a rule-based system. For example, at (block 702), the rule-based management tool 108 identifies all productions rules associated with a first policy of a web-platform implementing the rule-based system, e.g., all of the production rules of PPA. Further, at (block 704), the processing device identifies all production rules associated with a second policy of the web-based platform, e.g., all production rules associated with SYI. Additionally, at (block 706), the processing device identifies metadata or more specifically, metadata associated with variables of the rule-based system.

At (block 708), the rule-based management tool 108 passes the information to an embedding converter and the embedding converter converts the information into embeddings and store the embeddings in a database, e.g., an embeddings database.

In some examples, (block 702) through (block 708) include background operations. As new rules are added to the rule-based system, the new rules are converted into embedding and stored in the database via these operations.

At (block 710), the rule-based management tool 108 receives user input that includes any query, e.g., a query related to insights or rule unification of a policy of the rule-based system.

Upon receiving the user input, the rule-based management tool 108 performs data preparation at (block 718). As part of data preparation, the rule-based management tool 108 forms queries to query the different databases associated with the rule-based system. For example, the rule-based management tool 108 queries the embeddings database, a EURA database, or a prompts database. The rule-based management tool 108 obtains data from querying the databases and pass the information to an LLM at (block 720). The LLM analyzes the data and output insight information or rule-unification information in an organized manner as described with reference to FIGS. 1 and 2.

### Example Procedure for Rule-based System Management

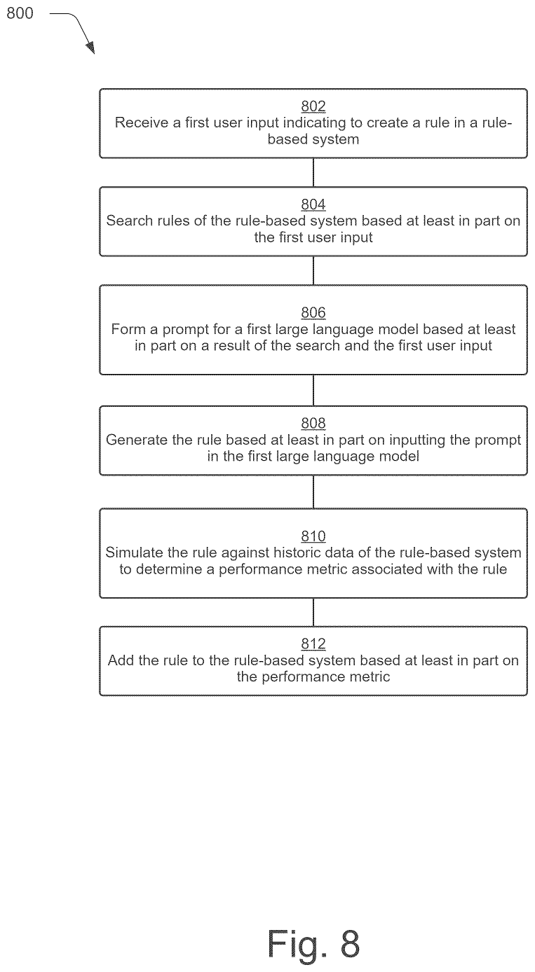

FIG. 8 illustrates an example of a procedure 800 that supports multi-agent rule-based system management using one or more LLMs as described herein. The operations of the procedure are implemented by a rule-based management system as described herein. It should be noted that the procedure described herein describes a possible implementation, and that the operations and the steps are be rearranged or otherwise modified and that other implementations are possible.

At (block 802), first user input indicating to create a rule in a rule-based system is received. By way of example, a rule engine receives a first user input indicating to create a rule in a rule-based system, e.g., the rule engine 110 or the rule manager 302.

At (block 804), rules of the rule-based system are searched based at least in part on the first user input. By way of example, a search component searches rules of the rule-based system based at least in part on the first user input, e.g., the search agent 116 or the search component 304. In some implementations, none of the rules of the rule-based system are determined to match the rule based at least in part on the search.

At (block 806), a prompt for a first LLM is formed based at least in part on a result of the search and the first user input. By way of example, a prompt component forms a prompt for a first LLM based at least in part on a result of the search and the first user input, e.g., the rule generation agent 114 or the prompt component 306.

At (block 808), the rule is generated based at least in part on inputting the prompt in the first LLM. By way of example, a rule generator component generates the rule based at least in part on inputting the prompt in the first LLM, e.g., the rule generation agent 114 or the rule generator component 308. In some implementations, the rule is generated by generating a new rule or modifying an existing rule of the rule-based system. In some implementations, the rule is displayed via a user interface based at least in part on generating the rule.

At (block 810), the rule is simulated against historic data of the rule-based system to determine a performance metric of the rule. By way of example, a performance component simulates the rule against historic data of the rule-based system to determine a performance metric of the rule, e.g., the rule generation agent 114 or the performance component 310.

At (block 812), the second rule is added to the rule-based system based at least in part on the performance metric. By way of example, a publish component adds the second rule to the rule-based system based at least in part on the performance metric, e.g., the rule generation agent 114 or the publish component 312. In some implementations, the rule is added to the rule-based system based at least in part on the performance metric exceeding a threshold.

In some implementations, a second user input requesting insight information for a policy of the rule-based system is received, a query is generated based at least in part on inputting the second user input in a second LLM, embeddings data related to the rules or policies of the rule-based system is obtained from one or more databases based at least in part on the query, and insight information is generated based at least in part on the embeddings data. In some implementations, the insight information includes one or more of a list of rules related to the policy, a usage history of the rules related to the policy, a performance metric for the rules related to the policy, or a pair of co-firing rules. In some implementations, a pair of co-firing rules is determined based at least in part on obtaining rule firing data from the one or more databases in response to the query and one of the rules of the pair are removed from the rule-based system.

### Example System for Rule-based System Management

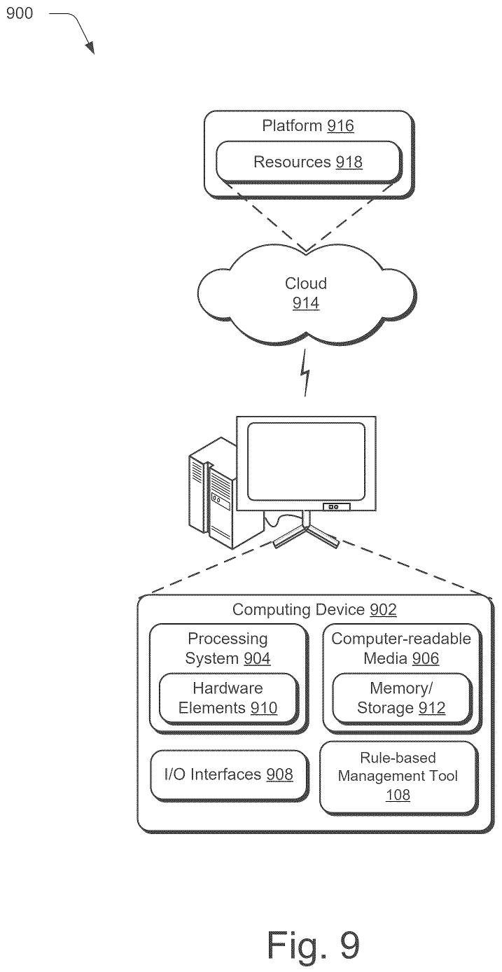

FIG. 9 illustrates an example of system 900 that supports multi-agent rule-based system management using one or more LLMs as described herein. The system 900 includes a computing device 902 that is representative of one or more computing systems and/or devices that implement the various techniques described herein. This is illustrated through inclusion of the rule-based management tool 108. The computing device 902 is, for instance, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that are configured as processors, functional blocks, and so forth. This includes implementation in hardware as an application specific integrated circuit or other logic device formed using one or more semiconductors. The hardware elements 910 are not limited by the materials from which the hardware elements 910 are formed or the processing mechanisms employed therein. For instance, processors include semiconductor(s) and/or transistors, e.g., electronic integrated circuits (ICs). In such a context, processor-executable instructions are electronically-executable instructions.

The computer-readable media 906 is illustrated as including memory/storage 912. The memory/storage 912 represents memory/storage capacity associated with one or more computer-readable media. The memory/storage 912 includes volatile media, such as random-access memory (RAM), and/or nonvolatile media, such as read only memory (ROM), Flash memory, optical disks, magnetic disks, and so forth. The memory/storage 912 includes fixed media (e.g., RAM, ROM, a fixed hard drive, and so on) as well as removable media, e.g., Flash memory, a removable hard drive, an optical disc, and so forth. The computer-readable media 906 is configured in a variety of other ways as further described below.

Input/output interface(s) 908 are representative of functionality to allow a user to enter commands and information to computing device 902 and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which is employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implemented on a variety of commercial computing platforms having a variety of processors.

An implementation of the described modules and techniques are stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessed by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some implementations to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (For instance, one or more computing devices 902 and/or processing systems 904) to implement techniques, modules, and examples described herein.

The techniques described herein are supported by various configurations of the computing device 902 and are not limited to the specific examples of the techniques described herein. This functionality is also implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that are utilized while computer processing is executed on servers that are remote from the computing device 902. Resources 918 also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device implementation, implementation of functionality described herein is distributed throughout the system 900. For instance, the functionality is implemented in part on the computing device 902 as well as via the platform 916 that abstracts the functionality of the cloud 914.

In some aspects, the techniques described herein relate to a method, including: receiving a first user input indicating to create a rule in a rule-based system; searching rules of the rule-based system based at least in part on the first user input; forming a prompt for a first large language model based at least in part on a result of the search and the first user input; generating the rule based at least in part on inputting the prompt in the first large language model; simulating the rule against historic data of the rule-based system to determine a performance metric associated with the rule; and adding the rule to the rule-based system based at least in part on the performance metric.

In some aspects, the techniques described herein relate to a method further including: receiving a second user input requesting insight information for a policy of the rule-based system; generating a query based at least in part on inputting the second user input in a second large language model; obtaining, from one or more databases, embeddings data related to the rules or policies of the rule-based system based at least in part on the query; and generating the insight information based at least in part on the embeddings data. In some aspects, the insight information includes one or more of a list of rules related to the policy, a usage history of the rules related to the policy, performance metrics for the rules related to the policy, or a pair of co-firing rules.

In some aspects, the techniques described herein relate to a method further including: determining a pair of co-firing rules based at least in part on obtaining rule firing data from the one or more databases in response to the query; and removing one of the rules of the pair of co-firing rules from the rule-based system.

In some aspects, the techniques described herein related to a method further including: determining that none of the rules of the rule-based system match the rule based at least in part on the search. In some aspects, the techniques described herein related to a method further including: generating a new rule; or modifying an existing rule of the rule-based system. In some aspects, the techniques described herein related to a method further including: displaying, via a user interface, the rule based at least in part on generating the rule. In some aspects, the rule is added to the rule-based system based at least in part on the performance metric exceeding a threshold.

In some aspects, the techniques described herein relate to a method, including: receiving a first user input indicating to create a rule in a rule-based system; searching rules of the rule-based system based at least in part on the first user input; forming a prompt for a first large language model based at least in part on a result of the search and the first user input; generating the rule based at least in part on inputting the prompt in the first large language model; simulating the rule against historic data of the rule-based system to determine a performance metric associated with the rule; and adding the rule to the rule-based system based at least in part on the performance metric.

In some aspects, the techniques described herein relate to a method further including: receiving a second user input requesting insight information for a policy of the rule-based system; generating a query based at least in part on inputting the second user input in a second large language model; obtaining, from one or more databases, embeddings data related to the rules or policies of the rule-based system based at least in part on the query; and generating the insight information based at least in part on the embeddings data. In some aspects, the insight information includes one or more of a list of rules related to the policy, a usage history of the rules related to the policy, performance metrics for the rules related to the policy, or a pair of co-firing rules.

In some aspects, the techniques described herein relate to a method further including: determining a pair of co-firing rules based at least in part on obtaining rule firing data from the one or more databases in response to the query; and removing one of the rules of the pair of co-firing rules from the rule-based system.

In some aspects, the techniques described herein related to a method further including: determining that none of the rules of the rule-based system match the rule based at least in part on the search. In some aspects, the techniques described herein related to a method further including: generating a new rule; or modifying an existing rule of the rule-based system. In some aspects, the techniques described herein related to a method further including: displaying, via a user interface, the rule based at least in part on generating the rule. In some aspects, the rule is added to the rule-based system based at least in part on the performance metric exceeding a threshold.

In some aspects, the techniques described herein relate to a system including: one or more processors, and memory storing instructions that, when executed by the one or more processors, cause the system to perform operations including: receiving a first user input indicating to create a rule in a rule-based system; searching rules of the rule-based system based at least in part on the first user input; forming a prompt for a first large language model based at least in part on a result of the search and the first user input; generating the rule based at least in part on inputting the prompt in the first large language model; simulating the rule against historic data of the rule-based system to determine a performance metric associated with the rule; and adding the rule to the rule-based system based at least in part on the performance metric.

In some aspects, the techniques described herein relate to a system, the operations further including: receiving a second user input requesting insight information for a policy of the rule-based system; generating a query based at least in part on inputting the second user input in a second large language model; obtaining, from one or more databases, embeddings data related to the rules or policies of the rule-based system based at least in part on the query; and generating the insight information based at least in part on the embeddings data. In some aspects, the insight information includes one or more of a list of rules related to the policy, a usage history of the rules related to the policy, performance metrics for the rules related to the policy, or a pair of co-firing rules.

In some aspects, the techniques described herein relate to a system, the operations further including: determining a pair of co-firing rules based at least in part on obtaining rule firing data from the one or more databases in response to the query; and removing one of the rules of the pair of co-firing rules from the rule-based system.

In some aspects, the techniques described herein relate to a system, the operations further including: determining that none of the rules of the rule-based system match the rule based at least in part on the search. In some aspects, the techniques described herein relate to a system, the operations further including: generating a new rule; or modifying an existing rule of the rule-based system. In some aspects, the techniques described herein relate to a system, the operations further including: displaying, via a user interface, the rule based at least in part on generating the rule. In some aspects, the rule is added to the rule-based system based at least in part on the performance metric exceeding a threshold.

In some aspects, the techniques described herein relate to a non-transitory computer-readable storage medium storing instructions that, when executed by one or more processors, cause the one or more processors to perform operations including: receiving a first user input indicating to create a rule in a rule-based system; searching rules of the rule-based system based at least in part on the first user input; forming a prompt for a first large language model based at least in part on a result of the search and the first user input; generating the rule based at least in part on inputting the prompt in the first large language model; simulating the rule against historic data of the rule-based system to determine a performance metric associated with the rule; and adding the rule to the rule-based system based at least in part on the performance metric.

In some aspects, the techniques described herein relate to a non-transitory computer-readable storage medium, the operations further including: receiving a second user input requesting insight information for a policy of the rule-based system; generating a query based at least in part on inputting the second user input in a second large language model; obtaining, from one or more databases, embeddings data related to the rules or policies of the rule-based system based at least in part on the query; and generating the insight information based at least in part on the embeddings data. In some aspects, the insight information includes one or more of a list of rules related to the policy, a usage history of the rules related to the policy, performance metrics for the rules related to the policy, or a pair of co-firing rules.

In some aspects, the techniques described herein relate to a non-transitory computer-readable storage medium, the operations further including: determining a pair of co-firing rules based at least in part on obtaining rule firing data from the one or more databases in response to the query; and removing one of the rules of the pair of co-firing rules from the rule-based system.

In some aspects, the techniques described herein relate to a non-transitory computer-readable storage medium, the operations further including: determining that none of the rules of the rule-based system match the rule based at least in part on the search. In some aspects, the techniques described herein relate to a non-transitory computer-readable storage medium, the operations further including: generating a new rule; or modifying an existing rule of the rule-based system. In some aspects, the techniques described herein relate to a non-transitory computer-readable storage medium, the operations further including: displaying, via a user interface, the rule based at least in part on generating the rule. In some aspects, the rule is added to the rule-based system based at least in part on the performance metric exceeding a threshold.

What is claimed is:

1. A method for rule-based system management, comprising:
receiving a first user input indicating to create a rule in a rule-based system;
searching rules of the rule-based system based at least in part on the first user input;
forming a prompt for a first large language model based at least in part on a result of the search and the first user input;
generating the rule based at least in part on inputting the prompt in the first large language model;
simulating the rule against historic data of the rule-based system to determine a performance metric associated with the rule; and
adding the rule to the rule-based system based at least in part on the performance metric.

2. The method of claim 1, further comprising:
receiving a second user input requesting insight information for a policy of the rule-based system;
generating a query based at least in part on inputting the second user input in a second large language model;
obtaining, from one or more databases, embeddings data related to the rules or policies of the rule-based system based at least in part on the query; and
generating the insight information based at least in part on the embeddings data.

3. The method of claim 2, wherein the insight information comprises one or more of a list of rules related to the policy, a usage history of the rules related to the policy, performance metrics for the rules related to the policy, or a pair of co-firing rules.

4. The method of claim 2, further comprising:
determining a pair of co-firing rules based at least in part on obtaining rule firing data from the one or more databases in response to the query; and
removing one of the rules of the pair of co-firing rules from the rule-based system.

5. The method of claim 1, further comprising:
determining that none of the rules of the rule-based system match the rule based at least in part on the search, wherein forming the prompt is based at least in part on determining that none of the rules of the rule-based system match the rule.

6. The method of claim 1, wherein generating the rule comprises:
generating a new rule; or
modifying an existing rule of the rule-based system.

7. The method of claim 1, further comprising:
displaying, via a user interface, the rule based at least in part on generating the rule.

8. The method of claim 1, wherein the rule is added to the rule-based system based at least in part on the performance metric exceeding a threshold.

9. A system, comprising:
one or more processors; and
memory storing instructions that, when executed by the one or more processors, cause the system to perform operations comprising:
receiving a first user input indicating to create a rule in a rule-based system;
searching rules of the rule-based system based at least in part on the first user input;
forming a prompt for a first large language model based at least in part on a result of the search and the first user input;
generating the rule based at least in part on inputting the prompt in the first large language model;
simulating the rule against historic data of the rule-based system to determine a performance metric associated with the rule; and
adding the rule to the rule-based system based at least in part on the performance metric.

10. The system of claim 9, the operations further comprising:
receiving a second user input requesting insight information for a policy of the rule-based system;
generating a query based at least in part on inputting the second user input in a second large language model;
obtaining, from one or more databases, embeddings data related to the rules or policies of the rule-based system based at least in part on the query; and
generating the insight information based at least in part on the embeddings data.

11. The system of claim 10, wherein the insight information comprises one or more of a list of rules related to the policy, a usage history of the rules related to the policy, performance metrics for the rules related to the policy, or a pair of co-firing rules.

12. The system of claim 10, the operations further comprising:
determining a pair of co-firing rules based at least in part on obtaining rule firing data from the one or more databases in response to the query; and
removing one of the rules of the pair of co-firing rules from the rule-based system.

13. The system of claim 9, the operations further comprising:
determining that none of the rules of the rule-based system match the rule based at least in part on the search, wherein forming the prompt is based at least in part on determining that none of the rules of the rule-based system match the rule.

14. The system of claim 9, the operations to generate the rule comprising:
generating a new rule; or
modifying an existing rule of the rule-based system.

15. The system of claim 9, the operations further comprising:
displaying, via a user interface, the rule based at least in part on generating the rule.

16. The system of claim 9, wherein the rule is added to the rule-based system based at least in part on the performance metric exceeding a threshold.

17. A non-transitory computer-readable storage medium storing instructions that, when executed by one or more processors, cause the one or more processors to perform operations comprising:
receiving a first user input indicating to create a rule in a rule-based system;
searching rules of the rule-based system based at least in part on the first user input;
forming a prompt for a first large language model based at least in part on a result of the search and the first user input;
generating the rule based at least in part on inputting the prompt in the first large language model;
simulating the rule against historic data of the rule-based system to determine a performance metric associated with the rule; and
adding the rule to the rule-based system based at least in part on the performance metric.

18. The non-transitory computer-readable storage medium of claim 17, the operations further comprising:
receiving a second user input requesting insight information for a policy of the rule-based system;
generating a query based at least in part on inputting the second user input in a second large language model;
obtaining, from one or more databases, embeddings data related to the rules or policies of the rule-based system based at least in part on the query; and
generating the insight information based at least in part on the embeddings data.

19. The non-transitory computer-readable storage medium of claim 17, the operations further comprising:
determining that none of the rules of the rule-based system match the rule based at least in part on the search, wherein forming the prompt is based at least in part on determining that none of the rules of the rule-based system match the rule.

20. The non-transitory computer-readable storage medium of claim 17, the operations to generate the rule comprising:
generating a new rule; or
modifying an existing rule of the rule-based system.
